(19) United States
(12) Patent Application Publication
(10) Pub. No.: US 2010/0314319 A1
(43) Pub. Date: Dec. 16, 2010

(54) HALOGENATED AMIDES AS BIOCIDES FOR BIOFILM CONTROL

(76) Inventors: Bei Yin, Buffalo Grove, IL (US); Charles D. Gartner, Midland, MI (US); Janardhanan S. Rajan, Glenview, IL (US); Sangeeta Ganguly, Chicago, IL (US); Steven Rosenberg, Shorewood, MN (US); Steven D. Jons, Eden Prairie, MN (US)

Correspondence Address: The Dow Chemical Company, P.O. BOX 1967, Midland, MI, 48641, US

(21) Appl. No.: 12/780,481

(22) Filed: May 14, 2010

Related U.S. Application Data
(60) Provisional application No. 61/179,161, filed on May 18, 2009.

(51) Int. Cl. C02F 1/76; C02F 1/44; E21B 43/26

(52) U.S. Cl. 210/638; 210/754; 210/747; 166/308.1

(57) ABSTRACT

Methods are provided for controlling sessile microorganisms and removing biofilm from an aqueous or moisture-containing system. The methods comprise treating the system with an effective amount of a compound of the formula I:

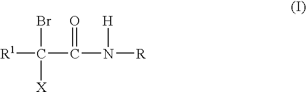

wherein X, R and R¹ are as defined herein.

### CROSS-REFERENCE TO RELATED APPLICATIONS

This application claims the benefit of U.S. Provisional Application Ser. No. 61/179,161, filed May 18, 2009, which is incorporated herein by reference in its entirety.

### FIELD OF THE INVENTION

The invention relates to methods for controlling biofilm in an aqueous or moisture-containing system by treating the system with a halogenated amide biocide.

### BACKGROUND OF THE INVENTION

Biofilms grow in almost any environment where there is a combination of microorganisms, moisture, nutrients, and a surface. In industry, biofilms occur in water-based processes, including water treatment and distribution. Biofilm formed by microorganism growth causes huge economic losses in industry through equipment and pipeline corrosion, system plugging, product failing, and energy losses. Biofilm is formed by a buildup of layers of microorganisms occupying a structured community encapsulated within a self developed polymeric matrix. Microorganisms within the biofilm are known as sessile microorganisms, whereas free floating non-biofilm microorganisms are planktonic.

By growing in biofilms, sessile microorganisms are more tolerant to antimicrobial treatment. 2,2-Dibromo-3-nitrilopropionamide (“DBNPA”), for example, is a commercially available biocide that is very effective at killing planktonic microorganisms; however, it is not as effective when used for biofilm treatment, primarily because of its quick hydrolysis and consequently short contact time with the sessile bacteria inside the biofilm.

Biocides that exhibit efficacy against biofilm-associated microorganisms are not necessarily efficient at removing a biofilm from a contaminated surface. The physical presence of the remnants of the biofilm (e.g., exopolysaccharides and dead bacteria cells) still lead to an uneven availability of oxygen to the metal surface that allows corrosion to occur. Thus, killing microorganisms in a biofilm without removing the biofilm from a surface may not always solve the corrosion problem.

It would be a significant advance in the industry to provide a biocide with high effectiveness against both planktonic and sessile cells, and has high capability of removing biofilm from a contaminated surface.

### BRIEF SUMMARY OF THE INVENTION

The invention provides a method for controlling sessile microorganisms and biofilm in an aqueous or moisture-containing system. The method comprised treating the aqueous or moisture containing-system with an effective amount of a compound of formula I:

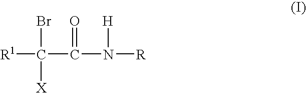

wherein X is halogen; and

R and R¹ are, respectively, hydroxyalkyl and a cyano radical (—C≡N), or

R and R¹ are, respectively, hydrogen and an amido radical of the formula:

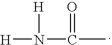

### BRIEF DESCRIPTION OF THE DRAWINGS

FIG. 1 is a bar graph showing reduction of viable sessile bacteria after biocide treatment for different time intervals.

FIG. 2 is a bar graph showing effectiveness of biocides at removing biofilm.

### DETAILED DESCRIPTION OF THE INVENTION

As noted above, the invention relates to methods for controlling biofilm in aqueous or moisture-containing systems. The method comprises treating the aqueous or moisture system with an effective amount of a compound of formula (I). The inventors have surprisingly discovered that compounds of formula (I) are effective at controlling sessile cells. In addition, the compounds are also effective at removing already formed biofilms in aqueous or moisture systems, such as from equipment surfaces operating in the system.

The compounds of formula (I) have the following chemical structure:

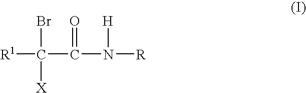

wherein X is halogen; and R and R¹ are, respectively, hydroxyalkyl and a cyano radical (—C≡N), or R and R¹ are, respectively, hydrogen and an amido radical of the formula:

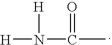

Preferably, X in the compounds of formula I is bromo, chloro, or iodo, more preferably it is bromo.

A preferred compound of formula (I) is 2,2-dibromo-2-cyano-N-(3-hydroxypropyl)acetamide.

A further preferred compound of formula (I) is 2,2-dibromomalonamide. The term “2,2-dibromomalonamide” means a compound of the following formula:

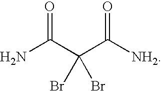

Compounds of formula (I) can be prepared by those skilled in the art using well known literature techniques.

In addition to their overall effectiveness against biofilms, the compounds of the invention are also surprisingly more resistant to hydrolysis at near-neutral-to-alkaline pH than other biocides. For instance, the Examples below demonstrate that at pH 6.9, 2,2-dibromomalonamide (DBMAL), an exemplary compound of the invention, is remarkably more stable than DBNPA (a comparative biocide). No loss of DBMAL is detected over 96 hours whereas 84% the DBNPA is lost in this same time frame at identical conditions.

Thus, in a further embodiment, the compounds of formula (I) are used in a method for controlling sessile microorganisms and biofilm in an aqueous or moisture-containing system, wherein the aqueous or moisture containing component has a pH of 5 or greater. In some embodiments, the pH is 6 or greater. In further embodiments, the pH is 7 or greater. In still further embodiments, the pH is 8 or greater.

Aqueous or moisture-containing systems that may be treated with the compounds of the invention include, but are not limited to, pulp and paper manufactory, cooling tower operation, heat exchangers, metalworking fluids, reverse osmosis water processing, oil and gas field injection, fracturing, and produced water, oil and gas wells and reservoirs, deaeration tower, oil and gas operation and transportation systems, oil and gas separation system and storage tanks, oil and gas pipelines, gas vessels, toilet bowls, swimming pools, household drains, household surfaces, process equipments, sewage systems, wastewater and treatment systems, other industrial process water, boiler system, ballast water, and equipments, pipes, tubes, and other surfaces in these systems. Preferred aqueous or moisture systems are paper and pulp manufactory, cooling tower operation, reverse osmosis water processing, oil and gas field operation, separation, transportation, and storage systems, pipelines, gas vessels, metal working fluids and membrane-based filtration systems.

Representative membrane-based filtration systems include those comprising one or more semi-permeable membranes, including but not limited to: microfiltration, ultrafiltration, nanofiltration, reverse osmosis and ion-exchange membranes. Applicable systems include those comprising a single type of membrane (e.g. microfiltration) and those comprising multiple types of membranes (e.g. ultrafiltration and reverse osmosis). For example, a membrane-based filtration system may comprise an upstream microfiltration or ultrafiltration membrane and a downstream nanofiltration or reverse osmosis membrane.

The subject biocidal compounds may be added to a feed solution prior to filtration, (e.g. added to a storage tank or pond containing feed solution to be treated) or during filtration, (e.g. dosed into a pressurized feed solution during filtration). Moreover, the subject biocidal compounds may be added to cleaning or storage solutions which contact the membrane. For purposes of this description, any aqueous solution (e.g. raw feed water, cleaning solution, membrane storage solution, etc.) contacting a membrane of a system is referred to as a “feed solution.”

When used within a system having both micro or ultrafiltration and nanofiltration or reverse osmosis membranes, the subject biocidal compounds provide biocidal effect to each membrane (e.g. both upstream and downstream membranes).

The portion of biocidal compound rejected by a membrane(s) may be recovered from the concentrate stream and recycled for use in subsequent treatments, (e.g. directed back to a storage tank or dosed within incoming feed). The recycle of biocidal compounds may be part of an intermittent or continuous process.

In many membrane-based filtration systems, the pH of the feed solution is at least 7, often at least 8, in some embodiments at least 9, and in other embodiments at least 10. Examples of such membrane-based systems are described U.S. Pat. No. 6,537,456 and U.S. Pat. No. 7,442,309. Moreover, membranes of many systems are commonly cleaned or stored with feed solutions having pH values of at least 11 and in some embodiments at least 12. Unlike DBNPA (as described in WO 2008/091453), the subject biocidal compounds remain effective under such neutral and alkaline conditions. As a consequence, the subject biocidal compounds may be added to a wider breath of feed solutions (e.g. pH adjusted aqueous feeds, aqueous cleaning solutions, aqueous storage solutions) used in connection with membrane-based filtration systems.

The type of membranes used in such systems are not particularly limited and include flat sheet, tubular and hollow fiber. One preferred class of membranes include thin-film composite polyamide membranes commonly used in nanofiltration and reverse osmosis applications, as generally described in U.S. Pat. No. 4,277,344; US 2007/0251883; and US 2008/0185332. Such nanofiltration and/or reverse osmosis membranes are commonly provided as flat sheets within a spiral wound configuration. Non-limiting examples of microfiltration and ultrafiltration membranes include porous membranes made from a variety of materials including polysulfones, polyethersulfones, polyamides, polypropylene and polyvinylidene fluoride. Such micro and ultrafiltration membranes are commonly provided as hollow fibers.

A person of ordinary skill in the art can readily determine, without undue experimentation, the effective amount of the compounds of formula I that should be used in any particular application. For example, an amount of at least 1 ppm, alternatively at least 5 ppm by weight, alternatively at least 10 ppm, or at least 50 ppm, is generally adequate. In some embodiments, the amount is 1000 ppm or less, alternatively 500 ppm or less or 300 ppm or less, or 200 ppm or less, or 100 ppm or less. In further embodiments, the amount is between about 20 and about 30 ppm.

The compounds of formula I can be used in the aqueous or moisture-containing system with other additives such as, but not limited to, surfactants, ionic/nonionic polymers and scale and corrosion inhibitors, oxygen scavengers, and/or additional biocides.

The compounds of formula I are useful for controlling a wide variety of microorganisms. In one embodiment, the microorganism are the Legionella species of bacteria, including such bacteria whose numbers are amplified by passage through amoeba. A preferred biocide for this Legionella embodiment is 2,2-dibromomalonamide.

Legionella bacteria have been implicated as the cause of Legionnaires' disease and Pontiac fever, collectively known as legionellosis. Many outbreaks of legionellosis have been attributed to evaporative cooling systems providing infectious doses. Legionella exhibit the relatively unique survival ability of parasitizing and residing within amoeba, eventually lysing their host cells to emerge as mature infectious forms. This mechanism has been suggested as the major means of amplification of Legionella numbers in natural and man made water systems and their increased virulence. A biocide that can effectively control Legionella, including forms of Legionella rendered more virulent by passage through amoeba, is highly desirable. As demonstrated by the examples, compounds of formula I, such as 2,2-dibromomalonamide, are effective for this such bacterial control.

The compounds described herein are surprisingly effective at controlling sessile/biofilm microorganisms than other biocides, including the commercial compound DBNPA, and therefore represent a significant advance to the industry.

For the purposes of this specification, “microorganism” means bacteria, algae, or viruses. The words “control” and “controlling” should be broadly construed to include within their meaning, and without being limited thereto, inhibiting the growth or propagation of sessile microorganisms, killing sessile microorganisms, disinfection, and/or preservation. “Control” and “controlling” also encompass the partial or complete removal of the sessile microorganisms' biofilm from a surface to which it is at least partially attached.

By “hydroxyalkyl” is meant an alkyl group (i.e., a straight and branched chain aliphatic group) that contains 1 to 6 carbon atoms and is substituted with a hydroxyl group. Examples include, but are not limited to, hydroxymethyl, hydroxyethyl, 2-hydroxypropyl, 3-hydroxypropyl, and the like.

“Halogen” refers to fluoro, chloro, bromo, or iodo.

Unless otherwise indicated, ratios, percentages, parts, and the like used herein are by weight.

The following examples are illustrative of the invention but are not intended to limit its scope.

### EXAMPLES

The following compositions are evaluated in the Examples:

2,2-Dibromo-3-nitrilopropionamide (“DBNPA”) is obtained from The Dow Chemical Company.

2,2-Dibromomalonamide (“DBMAL”) is obtained from Johnson Mathey.

Glutaraldehyde is obtained from The Dow Chemical Company.

CMIT/MIT (5-chloro-2-methyl-4-isothiazolin-3-one and 2-methyl-4-isothiazolin-3-one) is obtained from The Dow Chemical Company.

Dioctyl dimethyl ammonium chloride is obtained from Lonza Inc.

### Example 1

### Preparation of 2,2-Dibromo-2-cyano-N-(3-hydroxypropyl)acetamide (DBCHA)

0.1 mole of 3-amino-1-propanol (7.51 grams) is added to a solution of 0.1 moles methyl cyanoacetate (10.1 grams) in methanol (40 grams). The mixture is stirred and heated to 60° C. for 30 minutes. The methanol solvent is vacuum stripped from the reaction product. The reaction product, without any further purification necessary, is dissolved in water and reacted with 0.1 mole of bromine (16.0 grams) and 0.03 mole of sodium bromate (5.0 grams), The reaction temperature is kept below 30° C. After the bromine and sodium bromate addition is complete the reaction mixture is allowed to stir for 30 minutes before neutralizing to pH 3 to 4 with dilute sodium hydroxide. Yield is 0.09 mole of 2,2-dibromo-2-cyano-N-(3-hydroxypropyl)acetamide (28 grams).

### Example 2

### Stability Against Hydrolysis

### Comparison of DBMAL and DBNPA

Dilute solutions (less than 0.5 wt %) of DBMAL and DBNPA are prepared at three different pHs. The pH is set and maintained, by using standard buffer solutions, at pH 6.9, 8.0 and 9.0. These solutions are then held at constant temperature at either −1° C. or 30° C. Periodically, aliquots are analyzed by HPLC to determine the level of DBMAL or DBNPA remaining. Results are shown in Table 1.

TABLE 1

| | Three DBNPA Samples | | | Three DBMAL Samples | | |
|---|---|---|---|---|---|---|
| | pH 9, | pH 8, | pH 6.9, | pH 9, | pH 8, | pH 6.9, |
| | T = −1 | T = −1 | T = 30 | T = −1 | T = −1 | T = 30 |
| Hours | C. | C. | C. | C. | C. | C. |
| 0 | 3842 | 4068 | 3991 | 4576 | 3866 | 3746 |
| 2 | 2818 | 3998 | 4155 | 4022 | 4031 | 4612 |
| 24 | 1256 | 3506 | 2557 | 3891 | 4191 | 3857 |
| 48 | 659 | 3578 | 1361 | 3603 | 4187 | 3935 |
| 72 | 363 | 3149 | 918 | 4018 | 4290 | 3966 |
| 96 | 239 | 3070 | 658 | 3456 | 3883 | 4212 |
| | Calculated Percent Reduction of the Active | | | | | |
| | Ingredient at Various Times | | | | | |
| 48 | 83 | 12 | 66 | 21 | 0 | 0 |
| 72 | 91 | 23 | 77 | 12 | 0 | 0 |
| 96 | 94 | 25 | 84 | 24 | 0 | 0 |

Table 1 shows that even at near-neutral conditions (pH=6.9) and a temperature of 30° C., DBMAL is remarkably more stable than DBNPA (a comparative biocide). No loss of DBMAL is detected over 96 hours whereas 84% the DBNPA is lost in this same time frame at identical conditions.

### Example 3

### Efficacy Against Biofilm Associated Bacteria

Biofilms of P. aeruginosa ATCC 10145 are grown in Calgary biofilm devices (Innovotech, Alberta, Canada) for 42 hours. Trypticase Soy Broth (TSB) is used in the biofilm devices as the culture medium. After the incubation period, loosely associated cells are removed from the biofilms that develop on the surfaces of the submerged pegs by rinsing with sterile 0.85% NaCl. The biofilms are than treated with DBMAL (inventive biocide), glutaraldehyde (comparative biocide), or DBNPA (comparative biocide). A dilute salts solution is used as the test medium for the efficacy studies. The salts solution contains (in grams per liter of deionized water) CaCl₂, 0.2203 g; MgSO₄, 0.1847 g; and NaHCO₃, 0.2033 g. The final pH of the solution is adjusted to 8.5.

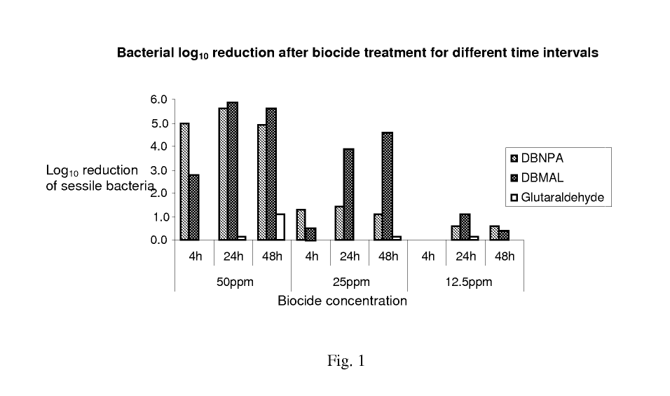

The concentrations of each active tested are 100 ppm, 50 ppm, 25 ppm, 12.5 ppm in the salts solution and the contact times are for 4 hours, 24 hours and 48 hours, respectively. In all cases, the incubation temperature is 37° C. Sterile deionized water is used as a non-biocide treated control. After each contact time, the pegs are washed with sterile 0.85% NaCl and the bacteria are released from the biofilm on the surface of each peg into sterile 0.85% NaCl by sonication (see Ceri et al., Journal of Clinical Microbiology 1999, 37: 1771-1776). The viable bacteria are then enumerated in TSB, using a serial dilution method. The data comparing DBMAL with DBNPA and glutaraldehyde is provided in FIG. 1.

In general, DBMAL (inventive biocide) is more effective than DBNPA (comparative biocide) against sessile bacteria. Glutaraldehyde only shows low effectiveness at 50 ppm active concentration after the 48 h treatment. At an active concentration of 25 ppm, DBMAL is a very effective biocide and its efficacy increases with contact time.

### Example 4

### Biofilm Removal Evaluation

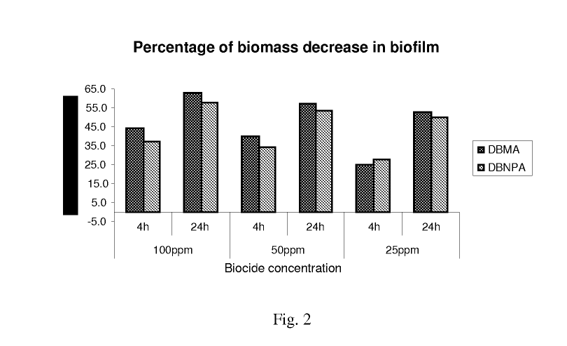

The Calgary biofilm device is used to prepare biofilms of P. aeruginosa ATCC 10145. TSB is used as the culture medium and biofilms are allowed to develop over a period of 42 hours. The pegs with biofilm growing on the surface are then washed with sterile 0.85% NaCl and then treated with DBMAL (inventive biocide) or DBNPA (comparative biocide). Concentrations of the actives tested are 25 ppm, 50 ppm, 100 ppm in sterile diluted salts solution as the test medium. The treatment is conducted at 37° C. for 4 hr and 24 hr, respectively. Sterile deionized water is used as an untreated control. After treatment, the pegs are washed with sterile 0.85% NaCl and then the biomass/biofilm on each peg is measured (see Stepanovic et al., Journal of Microbiological Methods, 2000, 40, 175-179). First the biofilm is fixed with 99% methanol and, after air drying, the pegs are stained with 2% (w/v) crystal violet and washed with tap water. The pegs are then air dried and the crystal violet bound to the biofilm is extracted with 33% glacial acetic acid. The optical density (OD) of the extracted solution is measured at 580 nm. The results are depicted in FIG. 2.

As can be seen from the data, DBMAL (inventive biocide) exhibits overall better biofilm removal than DBNPA (comparative biocide). The efficacy of biofilm removal improves with longer time for both materials (24 h comparing to 4 h).

### Example 5

### Control of Amoeba amplified Legionella

Since Legionella are amplified in natural and man made systems, such as cooling towers, by passage through amoeba, eradication of such amoeba fed Legionella forms, is more important and relevant. This example uses amoeba fed Legionella pneumophila (AfLp) in evaluating suitable biocides.

The Legionella are allowed to infect and grow inside amoeba (Acanthamoeba polyphaga) starting with a low multiplicity of infection (1 Legionella to 100 amoeba cells). Such a passage is repeated one more time allowing for establishment of the more virulent form as their dominant physiology, prior to exposure to various concentrations of biocides. The evaluations are conducted after two and twenty four hours of exposure. Appropriate neutralization of the biocides is carried out prior to enumeration of survivors. Table 6 below compares effectiveness of various biocides against both AfLp and free normally grown Legionella cells.

TABLE 2

| | Active concentration (ppm) required for | | | |
|---|---|---|---|---|
| | complete kill (6 log reduction) | | | |
| | | | Amoeba | |
| | Free Legionella | | fed Legionella | |
| Biocides | 2 hours | 24 hours | 2 hours | 24 hours |
| DBNPA | 12.5 | 3.12 | 50 | 25 |
| DBMAL | 6.25 | 1.56 | 12.5 | 3.12 |
| CMIT | 16 | 1 | >64 | 16 |
| Glutaraldehyde | 10 | 5 | 20 | 15 |
| Glutaraldehyde + DDAC | 2.5 | 1.25 | 20 | 10 |
| DDAC | 20 | 15 | 60 | 40 |

DDAC = didecyl dimethyl ammonium chloride

The data shows that for every biocide tested the amount needed to kill AfLp is greater than the amounts needed to kill free Legionella. However the amounts of DBMAL required for Legionella control is much lower than those needed for other tested biocides, including DBNPA. This is an unexpected and surprising finding. The levels of DBMAL needed for providing 6 log kills are only about twice that needed for controlling free cells at the corresponding time points. DBMAL provides a means of controlling the more virulent form of AfLp at low dosages when compared to other commonly used biocides.

While the invention has been described above according to its preferred embodiments, it can be modified within the spirit and scope of this disclosure. This application is therefore intended to cover any variations, uses, or adaptations of the invention using the general principles disclosed herein. Further, the application is intended to cover such departures from the present disclosure as come within the known or customary practice in the art to which this invention pertains and which fall within the limits of the following claims.

1. A method for controlling microorganisms in an aqueous or moisture-containing system, the method comprising treating the aqueous or moisture-containing system with an effective amount of a compound of formula I: 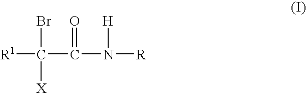
wherein X is halogen; and
R and R¹ are, respectively, hydroxyalkyl and a cyano radical (—C≡N), or
R and R¹ are, respectively, hydrogen and an amido radical of the formula: 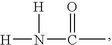
wherein the microorganisms being controlled are sessile microorganisms.

2. A method according to claim 1 wherein X is bromo.

3. A method according to claim 1 wherein the compound of formula (I) is: 2,2-dibromo-2-cyano-N-(3-hydroxypropyl)acetamide; 2,2-dibromomalonamide; or mixtures thereof.

4. A method according to claim 1 wherein the aqueous or moisture-containing system has a pH of 5 or greater.

5. A method according to claim 1 wherein the aqueous or moisture-containing system is: pulp and paper manufactory, cooling tower operation, heat exchangers, metalworking fluids, reverse osmosis water processing, oil and gas field injection, fracturing, and produced water, oil and gas wells and reservoirs, deaeration tower, oil and gas operation and transportation systems, oil and gas separation system and storage tanks, oil and gas pipelines, gas vessels, toilet bowls, swimming pools, household drains, household surfaces, process equipments, sewage systems, wastewater and treatment systems, other industrial process water, boiler system, ballast water, and equipments, pipes, tubes, and other surfaces in these systems.

6. A method according to claim 1 wherein the microorganism is bacteria.

7. A method according to any one of claim 1 wherein the microorganism is bacteria.

8. A method according to any one of claim 1 wherein the microorganism is species of the genus Legionella.

9. A method according to any one of claim 1 wherein the microorganism is a species Legionella that has reproduced inside living amoeba.

10. A method according to claim 1 wherein the system comprises a membrane-based filtration system comprising at least one semi-permeable membrane selected from at least one of: microfiltration, ultrafiltration, nanofiltration, reverse osmosis and ion exchange membranes; wherein the method comprises adding the compound of formula I to a feed solution followed by contacting the feed solution with the semi-permeable membrane.

11. A method according to claim 1 wherein the membrane-based filtration system comprises at least: i) one microfiltration or ultrafiltration membrane and ii) at least one nanofiltration or reverse osmosis membrane.

12. A method according to claim 1 wherein the feed solution has a pH of at least 9.

13. A method according to claim 1 wherein the feed solution has a pH of at least 11.
